(19) United States
(12) Patent Application Publication
(10) Pub. No.: US 2016/0069501 A1
(43) Pub. Date: Mar. 10, 2016

(54) FLUID LEAKAGE COUNTERACTION INSTRUMENT UPON DAMAGE OF FLUID CONVEYING PIPE

(71) Applicant: Sang Hwan CHOI, Ulsan-si (KR)

(72) Inventor: Sang Hwan CHOI, Ulsan-si (KR)

(21) Appl. No.: 14/744,008

(22) Filed: Jun. 18, 2015

(30) Foreign Application Priority Data
Jun. 18, 2014 (KR) 20-2014-0004589

(51) Int. Cl. F16L 55/18; F16L 41/04; F16L 55/168

(52) U.S. Cl. CPC F16L 55/18; F16L 55/1683; F16L 41/04

(57) ABSTRACT

The object of the present invention is to provide a fluid leakage counteraction instrument upon damage of fluid conveying pipe which can rapidly recover the damaged part in case where the conveying pipe is damaged so that the fluid is leaked.

The present invention is a fluid leakage counteraction instrument upon damage of fluid conveying pipe which is installed as to rapidly recover the damaged part of the conveying pipe which conveys the fluid, the instrument comprising: a recovery tubular body, at one end of which is installed a pad which can be closely attached to the damaged part of the conveying pipe, and at the other end of which is installed a valve; and a fixing means which can closely fix the pad installed at the recovery tubular body to the damaged part of the conveying pipe.

### TECHNICAL FIELD

The present invention relates to a fluid leakage counteraction instrument upon damage of fluid conveying pipe, and more particularly, it relates to a fluid leakage counteraction instrument upon damage of fluid conveying pipe which can rapidly recover the damaged part in case where the conveying pipe which conveys the fluid such as the liquid and the gas is damaged and the fluid is leaking.

### BACKGROUND OF THE INVENTION

In general, it is well known that conveying pipes are installed like a spider's web in various industrial facilities or general buildings.

These conveying pipes are one of the very important facilities and usually take charge of normal convey of fluid, however, in some cases, the conveying pipes are damaged due to excessive load, aging or external factor so that the fluid is leaked.

If the conveying pipes are damaged and the fluid is leaked as such, the operator closes the valve right away and replaces with new pipes or repairs by using joint coupling, however, there is a problem in that these operations are annoying and take a lot of times.

### PRIOR ART DOCUMENTS

### Patent Documents

(Patent Document 1) Domestic patent laid open publication KR 10-2008-0092764, a method of transferring pipes by using fluid interceptor for pipes.

(Patent Document 2) Domestic patent laid open publication KR 10-2010-0128555, a device for blocking the fluid pipes and a method of blocking the fluid pipes.

### SUMMARY OF THE INVENTION

The object of the present invention is to provide a fluid leakage counteraction instrument upon damage of fluid conveying pipe which can rapidly recover the damaged part in case where the conveying pipe is damaged so that the fluid is leaked.

The present invention to achieve the object described above is a fluid leakage counteraction instrument upon damage of fluid conveying pipe which is installed to recover a damaged part of the conveying pipe conveying the fluid such as fluid and gas, comprising: a recovery tubular body, at one end of which is installed a pad which can be closely attached to the damaged part of the conveying pipe, and at the other end of which is installed a valve; and a fixing means which can closely fix the pad installed at the recovery tubular body to the damaged part of the conveying pipe; wherein the fixing means comprises: a fixing band which is fixed in the form of wrapping the conveying pipe by being installed at the pad so as to closely fix the pad to the conveying pipe; and a clamp installed to fix the pad to press the conveying pipe from the outside of the pad so as to press and fix the pad, which is closely installed to the conveying pipe by the fixing band, to the conveying pipe; wherein the fixing band is at one end thereof formed with an opening so as to be installed in the form of wrapping the conveying pipe, and is installed with a fixture which can fix the opening, and wherein the clamp comprises upper and lower clamps in the form of half circle to be able to press the conveying pipe in the form of wrapping the conveying pipe, and can be pressed by screwing the upper and lower clamps by bolts and nuts.

It is preferred that the recovery tubular body comprises a discharge tubular body which can be inserted into the inside of the conveying pipe through the damaged part of the conveying pipe so as to discharge the fluid in the damaged part in the conveying pipe due to the pressure difference between the inside and the outside of the conveying pipe, and that the valve installed at the recovery tubular body to make it possible to install the recovery tubular body under the condition where the discharge tubular body is installed at the damaged part of the conveying pipe, and in addition, to make it possible to separate the discharge tubular body after installing the recovery tubular body is composed by a ball valve.

It is preferred that the pad installed at the recovery tubular body has a curved part formed to correspond to the exterior circumference of the conveying pipe so as to be closely attached to the exterior circumference of the conveying pipe, wherein one surface of the pad closely attached to the exterior circumference of the conveying pipe is provided with an adhesion means, and wherein the adhesion means is composed by one of adhesive tape and adhesives.

It is preferred that the recovery tubular body is installed with a pad fixing magnet so that the pad fixing magnet is placed at the outside of the pad, whereby the pad can be fixed to the exterior circumference of the conveying pipe, and wherein a clamping piece is installed to connect the pad fixing magnet and the pad so that the pad is pulled toward the magnet and fixed by the clamping piece.

It is preferred that a packing member having watertight property is installed between the pad of the recovery tubular body and the conveying pipe.

### Effect of the Present Invention

The present invention has an effect in that the maintenance operation is convenient and very economical by carrying out a complete maintenance operation by conveniently installing the present invention at the place of crack when the crack occurs at the fluid conveying pipes. That is, the present invention has an effect in that the maintenance operation on the damage or leakage in various pipes such as compound supplying and discharging lines in the industrial plant such as chemical plant including petrochemistry, pipes in ships, water, vapor, waste pipes in steel refinery, compound supplying and discharging lines in the automobile production plants, water supply and discharge lines in general buildings and schools, water supply pipe line and sewage pipe line, pipe line for city gas and LNG, pipes in public medical facilities is convenient and very economical.

### BRIEF DESCRIPTION OF THE DRAWINGS

FIG. 1 is a drawing showing a recovery tubular body provided in a fluid leakage counteraction instrument upon damage of fluid conveying pipe according to the present invention;

FIG. 2 is a drawing showing a discharge tubular body provided in a fluid leakage counteraction instrument upon damage of fluid conveying pipe according to the present invention;

FIG. 3 is a drawing showing a clamp provided in a fluid leakage counteraction instrument upon damage of fluid conveying pipe according to the present invention;

FIG. 4 is a side view of FIG. 3;

FIGS. 5a to 5e are drawings sequentially showing the installation states of a fluid leakage counteraction instrument upon damage of fluid conveying pipe according to the present invention;

FIG. 5a is a drawing showing the damaged part of the fluid conveying pipe;

FIG. 5b is a drawing showing a condition where the discharge tubular body is installed at the damaged part of the fluid conveying pipe;

FIG. 5c is a drawing showing a condition where the recovery tubular body is installed at the damaged part of the fluid conveying pipe where the discharge tubular body is installed;

FIG. 5d is a drawing showing a condition where a pad provided at the recovery tubular body is closely attached by a fixing band;

FIG. 5e is a drawing showing a condition where a pad provided at the recovery tubular body is fixed by pressing by a clamp;

FIG. 6 is a drawing showing an embodiment of a recovery tubular body provided in a fluid leakage counteraction instrument upon damage of fluid conveying pipe according to the present invention; and

FIG. 7 is a drawing showing a condition where the recovery tubular body shown in FIG. 6 is installed.

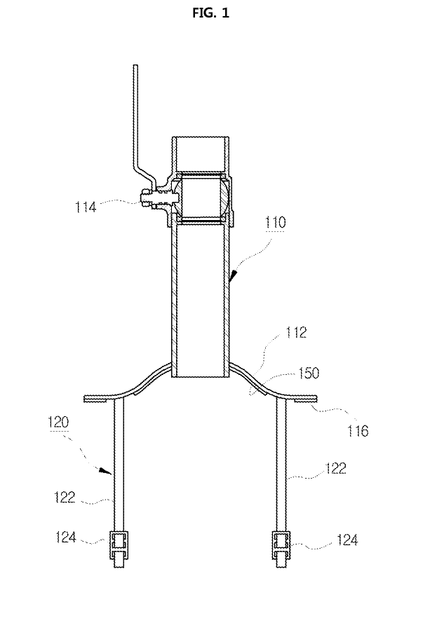

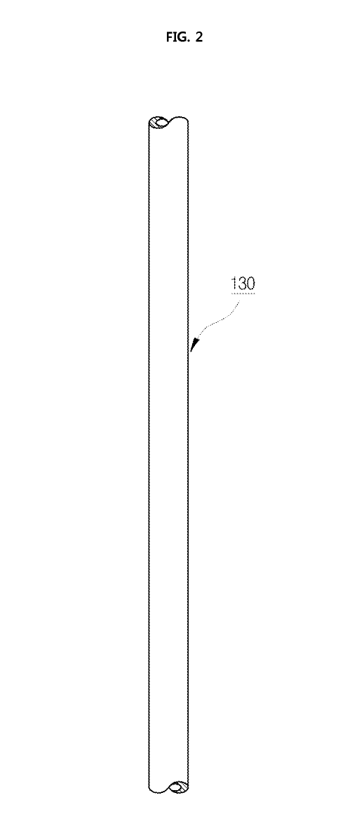

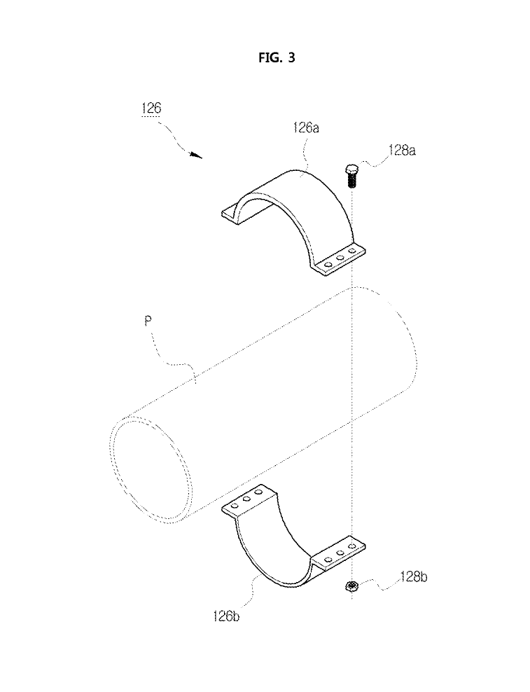

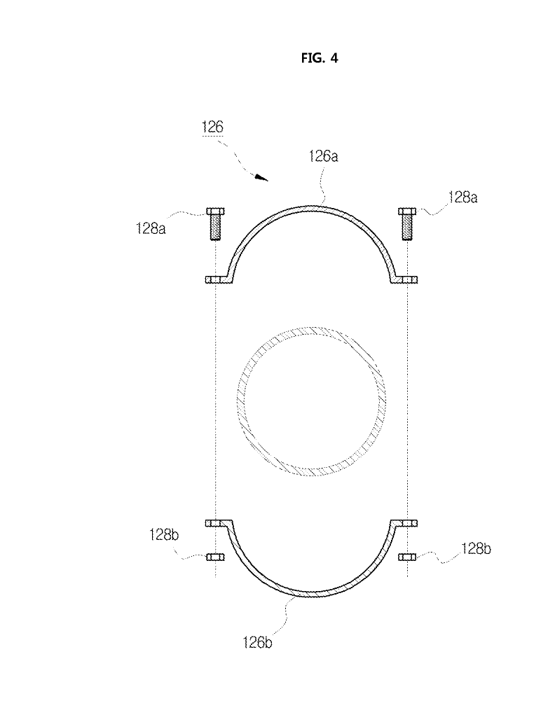

### DETAILED DESCRIPTION

Hereinafter, a preferred embodiment of the present invention will be described in more detail with reference to the accompanying drawings.

As shown in the drawings, a fluid leakage counteraction instrument upon damage of fluid conveying pipe according to the present invention is installed to rapidly recover the damaged part in case where the conveying pipe which conveys the fluid such as the liquid and the gas is damaged.

This fluid leakage counteraction instrument upon damage of fluid conveying pipe according to the present invention is provided with a recovery tubular body 110. The recovery tubular body 110 is installed with a pad 112 at its one end in such a way that the pad 112 can be closely attached to the damaged part of the conveying pipe P, and the recovery tubular body 110 is installed with a valve 114 at its other end.

Here, the pad 112 can be composed by a material such as the metal material or the rubber material, and in a case where the pad 112 is made of the metal material, it is preferred to form a curved part to correspond to the exterior circumference of the conveying pipe P to as to be able to be closely installed at the exterior circumference of the conveying pipe P.

That is, it is possible to prepare in advance a number of pads to have the curved part to correspond to the outer diameter of the conveying pipe P, and since the conveying pipe P is standardized, it is possible to prepare in advance a number of pads to correspond to the conveying pipe.

Meanwhile, in a case where the pad 112 is made of the rubber material, the pad 112 can be closely installed below the exterior circumference of the conveying pipe P due to the property of the rubber material.

Furthermore, an adhesion means 116 may be provided at one surface of the pad 112 which is closely attached to the exterior circumference of the conveying pipe P. The adhesion means 116 is preferably made of one of an adhesive tape or adhesives, and the pad 112 can be attached to the exterior circumference of the conveying pipe P by the adhesion means 116.

As shown in the drawings, the fluid leakage counteraction instrument upon damage of fluid conveying pipe according to the present invention is provided with a fixing means 120. The fixing means 120 closely fix the pad 112 installed at the recovery tubular body 110 to the damaged part of the conveying pipe P, and the fixing means 120 may be composed by a fixing band 122 or a clamp 126.

The fixing band 122 is installed at the pad 112 so as to closely fix the pad 112 to the conveying pipe P and the fixing band 122 can be fixed in the form of wrapping the conveying pipe P. At this time, in case where the fixing band 122 wraps the conveying pipe P, one side of the fixing band 122 should be opened to easily wrap the conveying pipe P, and to this end, one side of the fixing band 122 is formed with an opening, and a fixture 124 is installed at the opening to fix the opening.

Here, the fixture 124 may be in various forms such as a magic tape (namely, zzic-zzigi tape) or a buckle, and the pad 112 may be closely fixed to the conveying pipe P by directly tying the opening of the fixing band 122.

The clamp 126 can press and fix the pad 112 to the conveying pipe P. That is, the pad 112 can be pressed and fixed to the conveying pipe P by the clamp 126.

This clamp 126 is composed by an upper and lower clamps 126a, 126b in the form of a half circle to have an inner diameter corresponding to the outer diameter of the conveying pipe P so as to press the conveying pipe P in the form of wrapping, and the pressing can be done by screwing the upper and lower clamps 126a, 126b by bolts 128a and nuts 128b.

As shown in the drawings, a fluid leakage counteraction instrument upon damage of fluid conveying pipe according to the present invention is provided with a discharge tubular body 130. The discharge tubular body 130 can be inserted into the conveying pipe P through the damaged part c of the conveying pipe P before installing the recovery tubular body 110 at the damaged part c, and may be composed by a pipe or hose.

If such discharge tubular body 130 is inserted into the conveying pipe P through the damaged part c of the conveying pipe P, the fluid in the damaged part c in the conveying pipe P is discharged through the discharge tubular body 130 due to the pressure difference between the inside and the outside of the conveying pipe P, so that there is no fluid in the damaged part c.

In this condition, that is, in the condition where the discharge tubular body 130 is installed at the damaged part c of the conveying pipe P, the recovery tubular body 110 is installed so that the pad 112 is closely fixed to the exterior circumference of the conveying pipe P, and the damaged part c of the conveying pipe P is recovered.

As such, in order to install the recovery tubular body 110 in the condition where the discharge tubular body 130 is installed and to separate the discharge tubular body 130 after installing the recovery tubular body 110, it is preferable to install a ball valve at the recovery tubular body 110 since the discharge tubular body 130 is installed through the valve 114, and the recovery work is completed by closing the ball valve after separating the discharge tubular body 130.

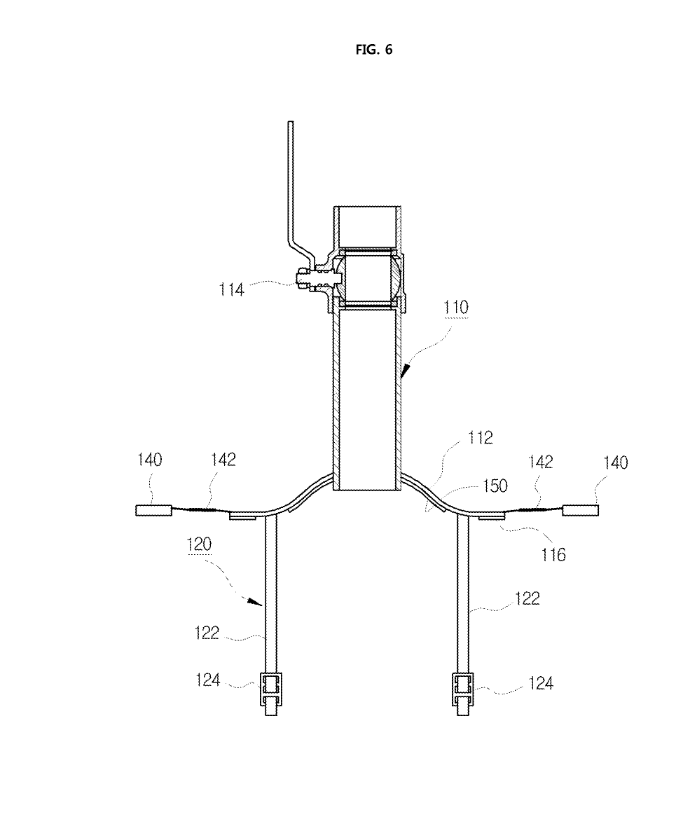

As shown in the drawings, a fluid leakage counteraction instrument upon damage of fluid conveying pipe according to the present invention may be installed with a pad fixing magnet 140 so that the pad fixing magnet 140 is placed outside of the pad 112 as shown in FIG. 6, whereby the pad 112 can be fixed at the exterior circumference of the conveying pipe P.

The pad fixing magnet 140 is installed to be connected with the pad 112 by a clamping piece 142, so that the pad 112 can be closely attached to the exterior circumference of the conveying pipe P by being pulled toward the magnet.

Here, the clamping piece 142 can be any clamping piece of all the known form, and can be composed by a wire, clamp, fixing piece, turnbuckle and the like as an example, and such structure is a common technological content and is simply shown as a rectangle.

In addition, a packing member 150 having watertight property can be installed between the pad 112 installed at the damaged part of the conveying pipe P and the conveying pipe P, and installing such watertight packing member 150 can further assuredly intercept the leakage under the condition where the pad 112 is closely fixed.

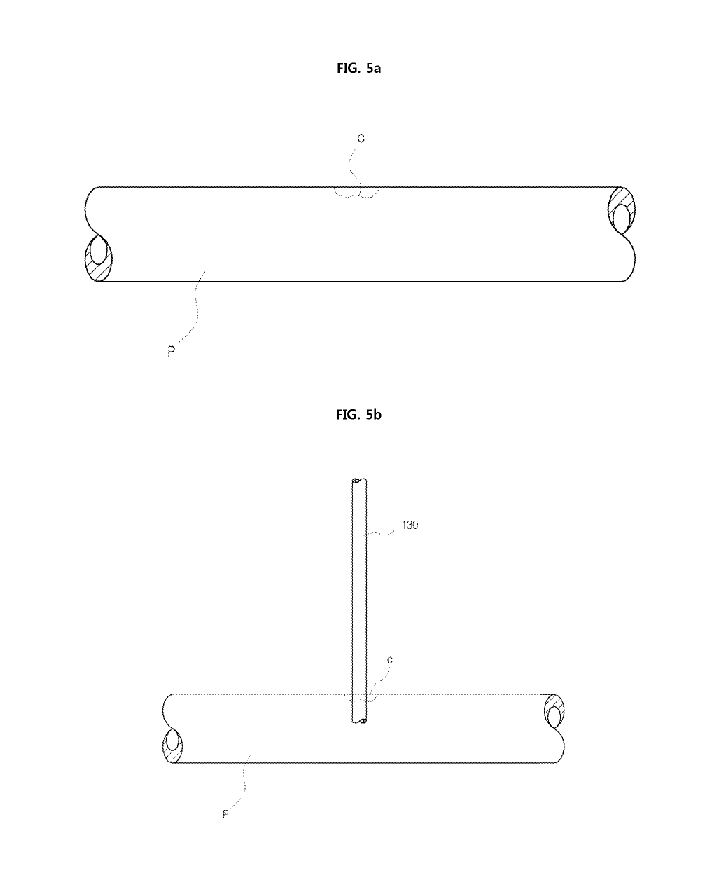

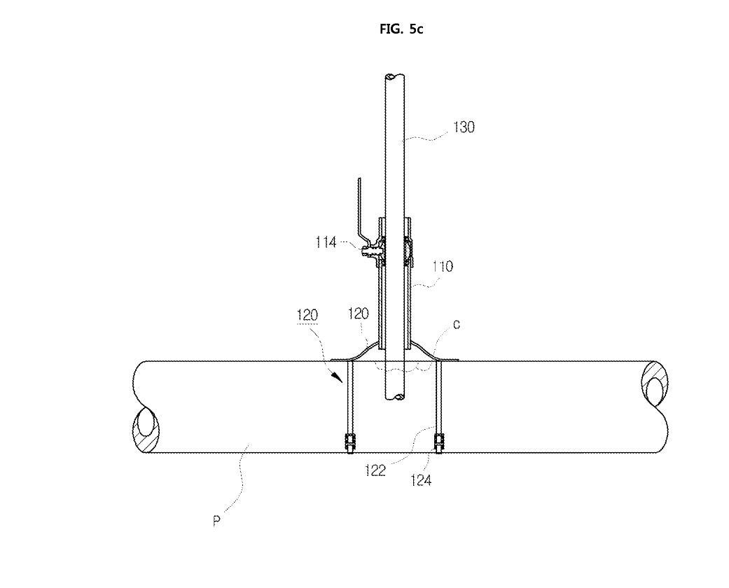

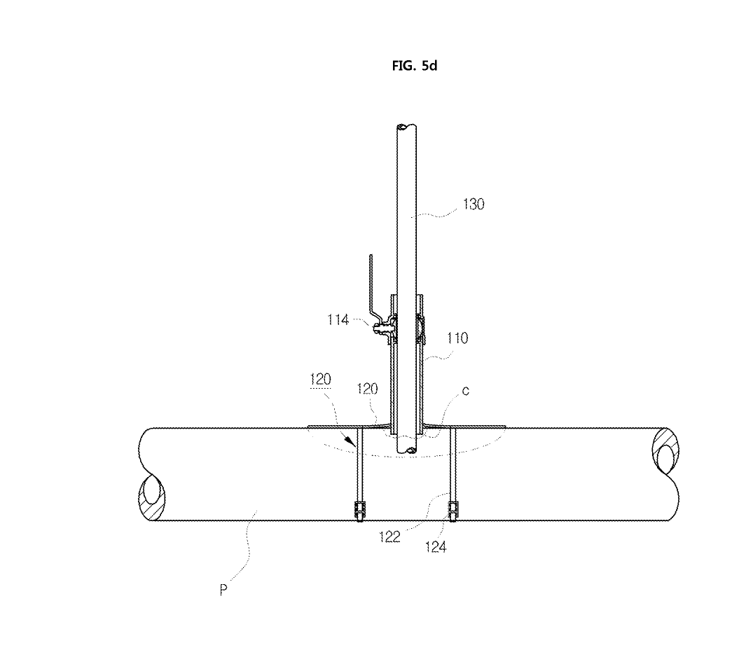

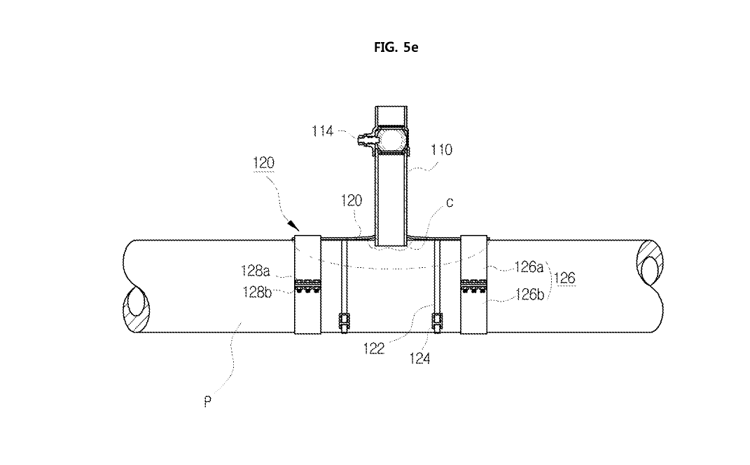

According to the present invention, if damage occurs at the conveying pipe P as shown in FIG. 5a, a discharge tubular body 130 composed by a rubber hose or pipe is inserted into inside of the conveying pipe P through the damaged part c as shown in FIG. 5b to recover the damaged part c. Then the fluid such as the water, oil and the like in the surround are removed due to the rising water level. That is, the fluid in the damaged part c is discharged by the discharge tubular body 130.

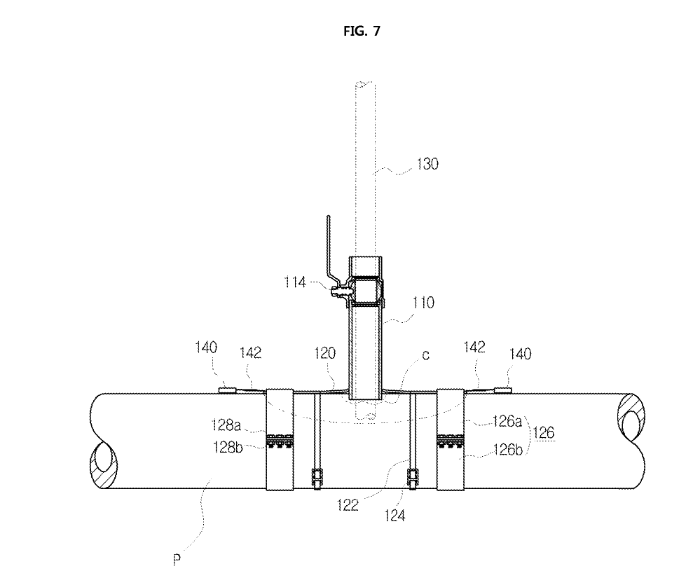

Thereafter, the pad 112 of the recovery tubular body 110 is closely installed at the exterior circumference of the conveying pipe P as shown in FIG. 5c and is fixed by the fixing means 120 as shown in FIG. 5d. At this time, in case where the conveying pipe P is the water supply pipe, the pad 112 can be fixed by welding, and in case where the fluid such as the oil or gas is conveyed through the conveying pipe P, the pad 112 can be pressed and fixed by the fixing band 122 and the clamp 126 as shown in FIG. 5e or can be pressed against and fixed to the conveying pipe P by the pad fixing magnet 140 and the clamping piece 142 as shown in FIG. 7.

After installing the recovery tubular body 110 as such, the recovery work is completed by removing the discharge tubular body 130 and closing the valve 114 provided at the recovery tubular body 110.

What is claimed is:

1. A fluid leakage counteraction instrument upon damage of fluid conveying pipe which is installed to recover a damaged part c of the conveying pipe P conveying the fluid such as fluid and gas, comprising:
a recovery tubular body 110, at one end of which is installed a pad 112 which can be closely attached to the damaged part c of the conveying pipe P, and at the other end of which is installed a valve 114; and
a fixing means 120 which can closely fix the pad 112 installed at the recovery tubular body 110 to the damaged part c of the conveying pipe P;
wherein the fixing means 120 comprises:
a fixing band 122 which is fixed in the form of wrapping the conveying pipe P by being installed at the pad 112 so as to closely fix the pad 112 to the conveying pipe P; and
a clamp 126 installed to fix the pad 112 to press the conveying pipe P from the outside of the pad 112 so as to press and fix the pad 112, which is closely installed to the conveying pipe P by the fixing band 122, to the conveying pipe P;
wherein the fixing band 122 is at one end thereof formed with an opening so as to be installed in the form of wrapping the conveying pipe P, and is installed with a fixture 124 which can fix the opening,
wherein the clamp 126 comprises upper and lower clamps 126a, 126b in the form of half circle to be able to press the conveying pipe P in the form of wrapping the conveying pipe P, and can be pressed and fixed by screwing the upper and lower clamps 126a, 126b by bolts 128a and nuts 128b,
wherein the recovery tubular body 110 is installed with a pad fixing magnet 140 so that the pad fixing magnet is placed at the outside of the pad 112, whereby the pad 112 can be fixed to the exterior circumference of the conveying pipe P, and
wherein a clamping piece 142 is installed to connect the pad fixing magnet 140 and the pad 112 so that the pad 112 is pulled and closely attached toward the magnet by the clamping piece 142.

2. The fluid leakage counteraction instrument upon damage of fluid conveying pipe of claim 1, wherein the recovery tubular body 110 comprises a discharge tubular body 130 which can be inserted into the inside of the conveying pipe P through the damaged part c of the conveying pipe P so as to discharge the fluid in the damaged part c in the conveying pipe P due to the pressure difference between the inside and the outside of the conveying pipe P, and
the valve 114 installed at the recovery tubular body 110 to make it possible to install the recovery tubular body 110 under the condition where the discharge tubular body 130 is installed at the damaged part c of the conveying pipe P, and in addition, to make it possible to separate the discharge tubular body 130 after installing the recovery tubular body 110 is composed by a ball valve.

3. The fluid leakage counteraction instrument upon damage of fluid conveying pipe of claim 1, wherein the pad 112 installed at the recovery tubular body 110 has a curved part formed to correspond to the exterior circumference of the conveying pipe P so as to be closely attached to the exterior circumference of the conveying pipe P,
wherein one surface of the pad 112 closely attached to the exterior circumference of the conveying pipe P is provided with an adhesion means 116, and
wherein the adhesion means 116 is composed by one of adhesive tape and adhesives.

4. The fluid leakage counteraction instrument upon damage of fluid conveying pipe of claim 1, wherein a packing member 150 having watertight property is installed between the pad 112 of the recovery tubular body 110 and the conveying pipe P.
